(19) United States
(12) Patent Application Publication
(10) Pub. No.: US 2020/0122931 A1
(43) Pub. Date: Apr. 23, 2020

(54) Apparatus for automatically replacing fountain pen refill

(71) Applicant: Wanli Chen, Dongguan City (CN)

(72) Inventor: Wanli Chen, Dongguan City (CN)

(21) Appl. No.: 16/721,925

(22) Filed: Dec. 20, 2019

(30) Foreign Application Priority Data
May 6, 2019 (CN) 2019103715812

(51) Int. Cl. B65G 29/00; B25J 15/00; B25J 15/08; B65G 47/24

(52) U.S. Cl. CPC B65G 29/00; B25J 15/0028; B43K 5/02; B65G 47/24; B25J 15/08

(57) ABSTRACT

The invention discloses an apparatus for automatically replacing fountain pen refill, and includes a box body, the left and right sides of the box body are respectively provided with a left inner cavity and a right inner cavity, an upper boss is fixedly connected to an inner wall of an upper part of the right inner cavity, and an inner wall of an upper part of the right inner cavity is fixedly connected to a lower boss at the lower left of the upper boss, a grooved wheel device is rotatably connected to the lower boss, a swivel rod device is connected below the swivel device, and a mechanical claw is fixedly connected to the lower part of the swivel device; The invention provides a relatively efficient automatic refill device, and at the same time, it can collect the used refills, which saves the time of refills and disposal of the used refills.

### CROSS-REFERENCES TO RELATED APPLICATIONS

The present application claims priority from Chinese application No. 2019103715812 filed on May 6, 2019 which is hereby incorporated by reference in its entirety.

### FIELD OF TECHNOLOGY

The invention relates to the field of stationery, and in particular relates to an apparatus for automatically replacing fountain pen refill.

### TECHNICAL FIELD

At present, the pen refills are replaced manually, and there is no device for automatic refill replacement. To this end, the present invention provides a relatively efficient device for automatically refilling cores, and at the same time can collect the used and refilled cores, saving the time for refilling and disposing of the cores.

### CONTENT OF THE INVENTION

An object of the present invention is to provide a device for automatically changing a pen refill, which can overcome the defects in the prior art.

According to the present invention, a device for automatically refilling a pen refill includes a box body, which is provided with a left inner cavity with an opening facing left, and a right side of the left inner cavity is provided with an opening facing upward and is aligned with the left inner The right inner cavity with the same cavity, the left opening of the left inner cavity and the upper opening of the right inner cavity are respectively provided with a lid opening device, and the lid opening device located at the left inner cavity opening can Open the box to take out the old pen core located in the left inner cavity, and the lid opening device located at the right inner cavity opening can open the box to replace the new pen located in the right inner cavity An upper boss is fixedly connected to the inner wall at the rear end of the right lumen, and a lower boss located at the lower left of the upper boss is fixed to the inner wall at the rear end of the right lumen; A baffle located below the lower boss is fixedly connected on the inner wall surface, the baffle is provided with a baffle through hole, and a sheave device is rotatably connected to the lower boss. The sheave device can be filled in batches. A new refill, and only a single refill is put in a single operation, a rotating rod device is connected below the groove wheel device, and the rotating rod The pen rod can be rotated. A mechanical claw is fixedly connected to the lower part of the rotating rod device. A screw extending left and right and located on the left side of the rocker is fixedly connected to the right inner cavity. The right inner cavity is rotationally connected. There is a left motor shaft extending left and right and located below the screw. The left end of the left motor shaft is dynamically connected with a left motor fixed to the inner wall of the right cavity. The right end of the left motor shaft is fixedly connected with a friction gear. The mechanical claws are threadedly connected, a left limit switch located above the left motor is fixedly connected to the inner wall of the right lumen, and a right limit switch located below the left motor is fixedly connected to the inner wall of the right lumen.

Preferably, the sheave device includes the lower boss which is rotatably connected with a sheave shaft extending up and down and located in the upper boss, and the sheave shaft is provided with a sheave located in the right inner cavity. Nine sheave through-holes are distributed in an annular array on the sheave. The sheave is provided with an outer groove located on the counter-clockwise side of the sheave through-hole. The middle boss is rotatably connected with an up-and-down extension and is located on the sheave. A helical gear shaft in the right inner cavity, a main motor fixed to the inner wall of the upper boss is dynamically connected to the top of the helical gear shaft, and an upper portion of the helical gear shaft is provided to abut against the sheave and is located in the A shift wheel below the main motor, a middle portion of the helical gear shaft is fixedly connected with a shift lever below the shift wheel, and an inner wall surface on the right side of the box body is fixedly connected with an upper limit switch positioned on the right side of the shift lever. The placement of a single refill is achieved through a sheave lever structure.

Preferably, taking the lid opening device of the right inner cavity as an example, the lid opening device includes an empty groove on the inner wall of the right end at the right cavity opening, and an upper slider is slidably connected in the empty groove. An upper spring is fixedly connected to the lower end surface of the upper slider, and a lower portion of the upper spring is fixedly connected to a lower wall surface in the empty slot; and an outer wall surface of the right inner cavity is hingedly located on the right side of the empty slot and is connected with An upper buckle plate that is engaged with the upper cover plate, a right spring is fixedly connected to the left wall surface of the lower section of the upper plate, and the lower end of the right spring is fixedly connected to the outer wall surface of the right inner cavity, which is achieved by the upper cover plate flip restriction. The opening and closing of the right inner cavity can be changed easily for installation.

Preferably, the swivel lever device includes a helical gear located below the shift lever in a lower portion of the helical gear shaft, and a right-side cavity is rotatably connected with a helical gear extending forward and backward and located on the right side of the helical gear shaft A large helical gear shaft, the large helical gear shaft is provided with a large helical gear meshingly connected with the helical gear, the transmission ratio between the large helical gear and the helical gear is 1:1, and the large helical gear is Large helical gear with incomplete teeth and a link connected to the upper part, a rocker is articulated to the lower part of the link, and a rocker shaft hinged to the rocker is rotatably connected to the middle part of the right inner cavity, and the rocker The mechanical claw is fixedly connected to the upper part, and the pen shaft is rotated through a structure similar to a crank rocker.

Preferably, taking the mechanical claw at the screw as an example, the mechanical claw includes a mechanical claw body that is threadedly connected to the screw, wherein the mechanical claw body is in meshing connection with the friction gear. The mechanical claw body is symmetrically provided with a claw body slot vertically. The mechanical claw body is symmetrically hinged with claw fingers. The right part of the claw finger is fixedly connected with a non-slip block vertically. A mechanical pawl spring is symmetrically fixedly connected, and the right side of the mechanical pawl spring is symmetrically and fixedly connected to the claw fingers. The claw fingers elastically connected can satisfy the fixing of pen rods of different diameters.

The beneficial effect of the present invention is that the present invention provides a relatively efficient device for automatically refilling a pen, and at the same time can collect the used refills, which saves the time of refilling and disposing of the used refills.

### BRIEF DESCRIPTION OF THE DRAWINGS

For ease of description, the present invention is described in detail by the following specific embodiments and the accompanying drawings.

FIG. 1 is a schematic diagram of an overall structure of a device for automatically replacing a pen refill according to the present invention;

FIG. 2 is a schematic structural diagram of “A-A” of FIG. 1;

FIG. 3 is a schematic structural diagram of “B-B” of FIG. 1;

FIG. 4 is an enlarged schematic view of the structure of “C” in FIG. 1.

### DETAILED DESCRIPTION OF THE INVENTION

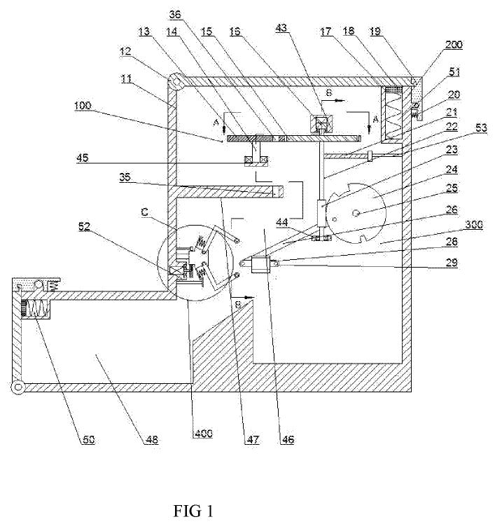

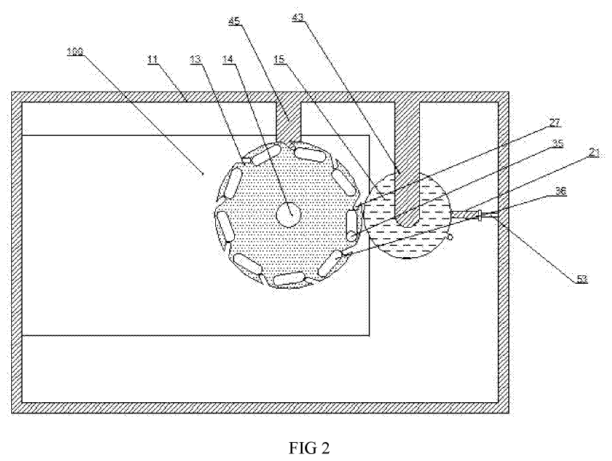

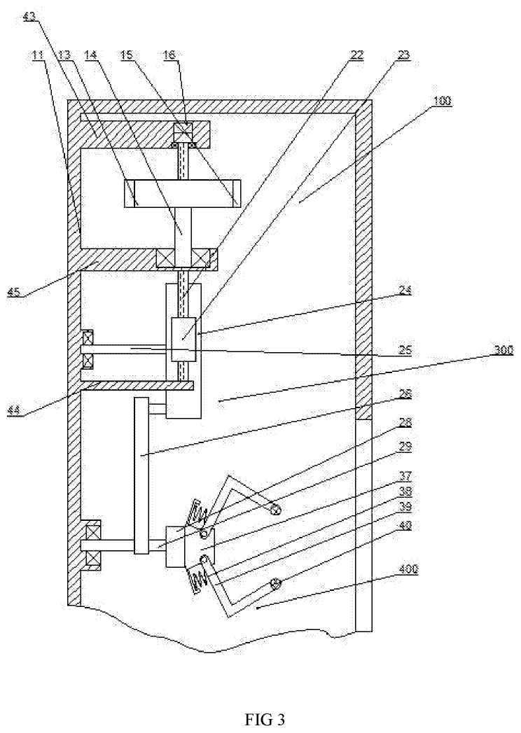

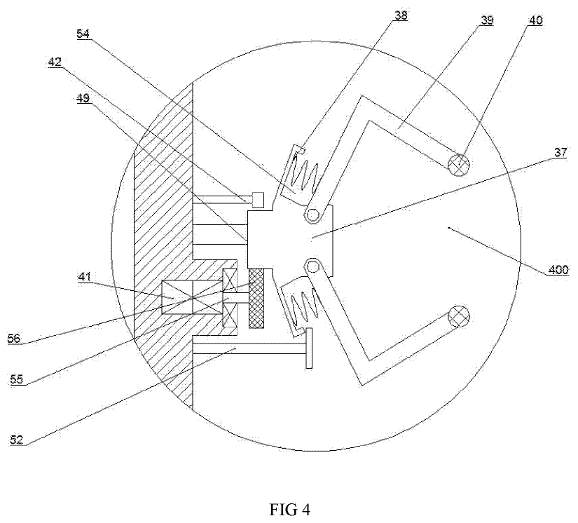

The present invention is described in detail below with reference to FIGS. 1-4. For convenience of description, the orientation described below is defined as follows: the up-down, left-right, front-back direction described below is consistent with the up-down, left-right, front-back direction of the projection relationship of FIG.

According to the present invention, a device for automatically refilling a pen refill includes a box body 11 which is provided with a left inner cavity 48 with an opening facing left, and a right side of the left inner cavity 48 is provided with an opening facing upward and is in contact with The left inner cavity 48 communicates with the right inner cavity 46, and a left opening of the left inner cavity 48 and an opening on the upper side of the right inner cavity 46 are provided with lid opening devices 200 respectively, which are located in the left inner cavity. The lid opening device 200 at the opening 48 can open the case 11 to take out the old refill located in the left inner cavity 48, and the lid opening device 200 at the opening of the right inner cavity 46 can be opened. The box 11 is thus replaced with a new refill located in the right inner cavity 46. An upper boss 43 is fixedly connected to the inner wall of the rear end of the right inner cavity 46, and an inner wall of the rear end of the right inner cavity 46 is fixedly connected. A lower boss 45 located at the lower left of the upper boss 43, and a baffle 47 located below the lower boss 45 is fixedly connected to the inner wall surface of the rear end of the right inner cavity 46, and the baffle 47 is opened. Plate through hole 35, a grooved wheel device 100 is rotatably connected to the lower boss 45, and the grooved wheel device 100 can fill new refills in batches, and only a single pen is put in a single operation A rotating rod device 300 is connected below the grooved wheel device 100, and the rotating rod device 300 can rotate the pen rod. A mechanical claw 400 is fixedly connected to a lower portion of the rotating rod device 300, and the right inner cavity 46 is fixed therein. A screw 49 extending left and right and located on the left side of the rocker 28 is connected, and a left motor shaft 55 extending left and right and located below the screw 49 is rotatably connected to the left end of the left motor shaft 55 A left motor 41 fixed to an inner wall of the right inner cavity 46 is connected, a right end of the left motor shaft 55 is fixedly connected to a friction gear 56, the screw 49 and the mechanical claw 400 are threadedly connected, and the right inner cavity 46 is connected. A left limit switch 42 located above the left motor 41 is fixedly connected to the inner wall, and a right limit switch 52 located below the left motor 41 is fixedly connected to the inner wall of the right inner cavity 46.

Beneficially, the sheave device 100 includes the lower boss 45 rotatably connected with a sheave shaft 14 extending up and down and located in the upper boss 43. The sheave shaft 14 is provided with a right inside cavity 46. The sheave 13 has nine sheave through-holes 36 distributed in a circular array on the sheave 13. The sheave 13 is provided with an outer groove 27 located on the counterclockwise side of the sheave through-hole 36. A helical gear shaft 22 extending up and down and located in the right inner cavity 46 is rotatably connected to the table 44. A main motor 16 fixed to the inner wall of the upper boss 43 is connected to the top of the helical gear shaft 22. The upper part of the gear shaft 22 is provided with a dial 15 that abuts the sheave 13 and is located below the main motor 16. The middle part of the helical gear shaft 22 is fixedly connected with a shift lever 21 located below the dial 15. An upper limit switch 53 located on the right side of the shift lever 21 is fixedly connected to the inner wall surface on the right side of the box 11, and a single pen core is put in through a grooved wheel lever structure.

Beneficially, taking the lid opening device 200 of the right inner cavity 46 as an example, the lid opening device includes an empty groove 51 on the inner wall of the right end at the opening of the right internal cavity 46, and the empty groove 51 is slidably connected in the inside. There is an upper slider 17, and an upper spring 18 is fixedly connected to the lower end surface of the upper slider 17. The lower part of the upper spring 18 is fixedly connected to the lower wall surface in the hollow groove 51. The outer wall surface of the right inner cavity 46 is hinged. An upper buckle plate 19 is located on the right side of the empty slot 51 and is engaged with the upper cover plate 12, and a right spring 20 is fixedly connected to the left wall surface of the lower part of the upper buckle plate 19, and the lower end of the right spring 20 is fixedly connected to the The outer wall surface of the right inner cavity 46 is described, and the opening and closing changes of the right inner cavity 46 are realized by the upper cover 12 turning restriction, which is convenient for taking and installation work.

Advantageously, the swivel lever device 300 includes a helical gear 23 located below the shift lever 21 at a lower portion of the helical gear shaft 22, and the right inner cavity 46 is rotatably connected with the helical gear extending forward and backward. A large helical gear shaft 25 on the right side of the shaft 22, the large helical gear shaft 25 is provided with a large helical gear 24 meshed with the helical gear 23, and the transmission ratio between the large helical gear 24 and the helical gear 23 The ratio is 1:1. The large helical gear 24 is an incompletely toothed helical gear and a link 26 is articulated on the upper portion. A rocker 28 is articulated on the lower portion of the link 26. The inner portion of the right inner cavity 46 is rotatably connected. There is a rocker shaft 29 hinged to the rocker 28. The rocker 28 is fixedly connected with the mechanical claw 400, and the pen shaft is rotated through a structure similar to a crank rocker.

Beneficially, taking the mechanical claw 400 at the screw 49 as an example, the mechanical claw 400 includes a mechanical claw body 37 screwed to the screw 49, wherein the mechanical claw body 37 and the friction gear 56 is engaged and mated. The mechanical claw body 37 is provided with claw body slots 54 symmetrically up and down. The mechanical claw body 37 is symmetrically hinged up and down with a claw finger 39. The right part of the claw finger 39 is fixedly connected with a non-slip block 40 vertically. A mechanical claw spring 38 is symmetrically fixed up and down on the left inner wall surface of the claw body slot 54. The right side of the mechanical claw spring 38 is symmetrically fixedly connected to the claw finger 39. The claw finger 39 is elastically connected. To meet the need to fix pens of different diameters.

At the beginning, the rocker 28 is located parallel to the horizontal plane, the left mechanical claw 400 is located at the maximum right displacement of the right limit switch 52, and the shift lever 21 is located at the position of the upper limit switch 53.

When working, put the water pen into the mechanical claw 400 at the rocker, and the pen tip is fixed to the mechanical claw 400 at the screw. The mechanical claw 400 exerts an elastic force on the claw finger 39 through the claw spring 38 to tighten and hold the claw finger 39 to hold the water pen. Start the left motor 41, make the friction gear 56 drive the mechanical claw body 37 to rotate leftward along the screw 49, so that the mechanical claw 400 at the screw 49 rotates counterclockwise to open the pen tip, and when the mechanical claw 400 at the screw contacts the left When the limit switch 42 is stopped, the left motor 41 is stopped and the main motor 16 is started at the same time. The main motor 16 drives the helical gear shaft 22 to rotate, the helical gear shaft 22 drives the large helical gear 24 to rotate, and the large helical gear 24 rotates by driving the link 26 to thereby rotate Drive the rocker shaft 29 to rotate. The rocker shaft 29 first rotates counterclockwise to the maximum hem angle and pours out the pen refill into the left inner cavity 48, and then rotates clockwise to the vertical position, that is, the maximum hem angle makes the pen mouth. Face the baffle through hole 35, and the axis of the water pen coincides with the axis of the baffle through hole 35. After the lever 21 dials the pen core from the grooved wheel through hole 36 into the baffle through hole 35 and falls into the pen shaft, shake The lever 28 is turned counterclockwise to the horizontal plane, and the lever 21 touches the upper limit position Close 53, stop the main motor 16 and start the left motor 41 at the same time. The left motor 41 drives the mechanical claw 400 at the screw to rotate the pen into the pen rod. When the mechanical claw 400 at the screw touches the right limit switch 52, the left motor 41 stop, complete the refill refill, and automatically replace the refill device to the initial position. When the new refill is replaced, you can open the upper cover to install the new refill, and open the left cover to remove the old refill.

The beneficial effect of the present invention is that the present invention provides a relatively efficient device for automatically refilling a pen, and at the same time can collect the used refills, which saves the time of refilling and disposing of the used refills.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. An apparatus for automatically replacing fountain pen refill, comprising a box body provided with a left inner cavity with an opening facing left, and a right side of the left inner cavity with an opening facing upward and connecting with the left inner cavity a lid opening device is provided on the right inner cavity, and a left opening of the left inner cavity and an opening on the upper side of the right inner cavity are respectively provided, and the lid opening device located at the left inner cavity opening can be opened. the box body thus takes out the old refill located in the left inner cavity, and the lid opening device located at the right inner cavity opening can open the box to replace the new refill located in the right inner cavity. an upper boss is fixedly connected to the inner wall at the rear end of the right lumen, and a lower boss located at the lower left of the upper boss is fixed to the inner wall at the rear end of the right lumen; a baffle located below the lower boss is fixedly connected on the wall surface, the baffle is provided with a baffle through hole, and a sheave device is rotatably connected to the lower boss. the sheave device can be filled with new batches. refill, and only a single refill is put in a single operation. a rotating rod device is connected below the groove wheel device, and the rotating rod device can the lever rotates, and a mechanical claw is fixedly connected to the lower part of the rotating rod device. the right inner cavity is fixedly connected with a screw extending left and right and located on the left side of the rocker, and the right inner cavity is rotationally connected with left and right extension. and a left motor shaft located below the screw, a left motor fixedly connected to an inner wall of the right cavity at a left end of the left motor shaft, a friction gear fixedly connected to a right end of the left motor shaft, and the screw and the machine a screw is connected between the claws, a left limit switch located above the left motor is fixedly connected to the inner wall of the right inner cavity, and a right limit switch located below the left motor is fixedly connected to the inner wall of the right inner cavity.

2. The apparatus for automatically replacing fountain pen refill according to claim 1, wherein the sheave device comprises a lower sheave rotatably connected with a sheave shaft which extends up and down and is located in the upper protrusion. The sheave shaft is provided with a sheave located in the right inner cavity. Nine sheave through holes are distributed in an annular array on the sheave, and the sheave is provided with a counterclockwise side on the sheave through hole. The outer groove is rotatably connected to the middle boss with a helical gear shaft extending up and down and located in the right inner cavity. The top of the helical gear shaft is dynamically connected with a main motor fixed to the inner wall of the upper boss. The upper part of the helical gear shaft is provided with a dial wheel that abuts the sheave and is located below the main motor. The middle part of the helical gear shaft is fixedly connected with a shift lever located below the dial wheel, and the box body. An upper limit switch located on the right side of the lever is fixedly connected to the inner wall surface of the right side, and a single pen core is put in through a grooved wheel lever structure.

3. The apparatus for automatically replacing fountain pen refill according to claim 1, wherein the opening device of the right inner cavity is taken as an example, and the opening device includes the opening of the right inner cavity An empty groove is provided on the inner wall of the right end, and an upper slider is slidably connected in the empty groove. An upper spring is fixedly connected to the lower end surface of the upper slider. The lower section of the upper spring is fixedly connected to the lower wall surface in the empty groove. An upper gusset plate located on the right side of the empty slot and engaged with the upper cover plate is hinged to the outer wall surface of the right inner cavity. A right spring is fixedly connected to the left wall surface of the lower section of the upper gusset plate, and a lower end of the right spring is fixed. It is connected to the outer wall surface of the right inner cavity, and the opening and closing changes of the right inner cavity are realized by the upper cover turning restriction, which is convenient for taking and installing work.

4. The apparatus for automatically replacing fountain pen refill according to claim 1 or 2, wherein the rotating lever device comprises a lower part of the helical gear shaft provided with a helical gear below the shift lever, A large helical gear shaft extending forward and backward and located on the right side of the helical gear shaft is rotatably connected in the right inner cavity. The large helical gear shaft is provided with a large helical gear meshed with the helical gear. The transmission ratio of the helical gear to the helical gear is 1:1, the large helical gear is an incomplete tooth large helical gear and a link is hinged on the upper part, a rocker is hinged on the lower part of the link, and the right inner cavity A rocker shaft hinged to the rocker is rotatably connected to the inner middle section, and the mechanical claw is fixedly connected to the rocker, and the pen shaft is rotated through a structure similar to a crank rocker.

5. The apparatus for automatically replacing fountain pen refill according to claim 1, wherein the mechanical claw at the screw is taken as an example, and the mechanical claw comprises a mechanical claw screwed to the screw The main body, wherein the mechanical claw body is meshed with the friction gear, the mechanical claw body is symmetrically provided with a claw body slot vertically, the mechanical claw body is symmetrically hinged with claw fingers, and the right part of the claw finger A non-slip block is symmetrically fixed up and down, and a mechanical claw spring is symmetrically fixed up and down on the left inner wall surface of the claw body slot. Claw fingers, which can be used to fix pens of different diameters.
